(19) United States
(12) Patent Application Publication
(10) Pub. No.: US 2026/0089747 A1
(43) Pub. Date: Mar. 26, 2026

(54) USER EQUIPMENT AND METHOD FOR SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/406,687

(22) Filed: Dec. 2, 2025

Related U.S. Application Data
(63) Continuation of application No. PCT/CN2023/112323, filed on Aug. 10, 2023.

(51) Int. Cl. H04W 72/40; H04L 1/1829; H04W 72/0446; H04W 72/25

(52) U.S. Cl. CPC H04W 72/40; H04L 1/1854; H04W 72/0446; H04W 72/25

(57) ABSTRACT

A method for determining a transmission gap between user equipments (UEs) in sidelink communication includes performing, by a UE, one or more operations to indicate to another UE, an ending time slot of a sidelink transmission and/or resources selected/reserved by the UE in a shared channel occupancy. The one or more operations include a first resource re-evaluation and pre-emption checking, a second resource re-evaluation and pre-emption checking, indicating a channel occupancy time (COT) sharing starting offset and/or a COT sharing region in a sidelink control information (SCI), and/or no dropping of any sidelink (SL) transmission within a COT after a COT sharing information (COT-SI) is transmitted in the SCI from the UE.

### CROSS-REFERENCE TO RELATED APPLICATION

The present disclosure is a Continuation Application of PCT/CN2023/112323 filed August 10, 2023, which is incorporated herein by reference in its entirety.

### BACKGROUND

### 1. Field of the Disclosure

The present disclosure relates to the field of communication systems, and more particularly, to a user equipment (UE) and a method for sidelink communication, which can provide a good communication performance and/or provide high reliability.

### 2. Description of the Related Art

In the advancement of radio wireless transmission and reception directly between two devices, which is often known as device-to-device (D2D) communication, it is first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Releases 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in power saving and transceiver link reliability. For Release 18, 3GPP is currently looking to evolve the wireless technology and expand its operation into unlicensed frequency spectrum. This is for larger available bandwidth, faster data transfer rate, and easier market adoption of D2D communication using sidelink without requiring any mobile cellular operator’s involvement to allocate and configure a part of their expansive precious radio spectrum for data services that do not go throughput their mobile networks.

Therefore, there is a need for a user equipment (UE) and a method for sidelink communication, which can solve issues in the prior art and other issues.

### SUMMARY

In a first aspect of the present disclosure, a method for determining a transmission gap between user equipments (UEs) in sidelink communication includes performing, by a UE, one or more operations to indicate to another UE, an ending time slot of a sidelink transmission and/or resources selected/reserved by the UE in a shared channel occupancy, wherein the one or more operations include a first resource re-evaluation and pre-emption checking, a second resource re-evaluation and pre-emption checking, indicating a channel occupancy time (COT) sharing starting offset and/or a COT sharing region in a sidelink control information (SCI), and/or no dropping of any sidelink (SL) transmission within a COT after a COT sharing information (COT-SI) is transmitted in the SCI from the UE.

In a second aspect of the present disclosure, a method for resource allocation in sidelink communication by a UE includes ensuring, by the UE, a sidelink hybrid automatic repeat request (SL-HARQ) feedback in a SL resource pool configured with physical sidelink feedback channel (PSFCH) resources to provide a minimum time gap between any two selected sets of resources of a selected sidelink grant, wherein at least one of the any two selected sets of resources is a set of consecutive-slot resources.

In a third aspect of the present disclosure, a UE includes an executor configured to perform one or more operations to indicate to another UE, an ending time slot of a sidelink transmission and/or resources selected/reserved by the UE in a shared channel occupancy. The one or more operations include: a first resource re-evaluation and pre-emption checking, a second resource re-evaluation and pre-emption checking, indicating a channel occupancy time (COT) sharing starting offset and/or a COT sharing region in a sidelink control information (SCI), and/or no dropping of any sidelink (SL) transmission within a COT after a COT sharing information (COT-SI) is transmitted in the SCI from the UE.

In a fourth aspect of the present disclosure, a UE includes an executor configured to ensure a sidelink hybrid automatic repeat request (SL-HARQ) feedback in a SL resource pool configured with physical sidelink feedback channel (PSFCH) resources to provide a minimum time gap between any two selected sets of resources of a selected sidelink grant, wherein at least one of the any two selected sets of resources is a set of consecutive-slot resources.

In a fifth aspect of the present disclosure, a user equipment (UE) includes a memory, a transceiver, and a processor coupled to the memory and the transceiver. The UE is configured to perform the above method.

In a sixth aspect of the present disclosure, a non-transitory machine-readable storage medium has stored thereon instructions that, when executed by a computer, cause the computer to perform the above method.

In a seventh aspect of the present disclosure, a chip includes a processor, configured to call and run a computer program stored in a memory, to cause a device in which the chip is installed to execute the above method.

In an eighth aspect of the present disclosure, a non-transitory computer readable storage medium, in which a computer program is stored, causes a computer to execute the above method.

In a ninth aspect of the present disclosure, a computer program product includes a computer program, and the computer program causes a computer to execute the above method.

In a tenth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method for determining a transmission gap between UEs in sidelink (SL) communication according to an embodiment of the present disclosure.

FIG. 5 is a flowchart illustrating a method for resource allocation in sidelink communication by a UE according to an embodiment of the present disclosure.

FIG. 6 is a schematic diagram illustrating a proposed SL resource selection and re-selection mechanism for a SL transmission according to an embodiment of the present disclosure.

FIG. 7 is a schematic diagram illustrating a proposed resource (re)selection method of ensuring a minimum time gap between two transmissions according to an embodiment of the present disclosure.

FIG. 8 is a block diagram of a UE for wireless communication according to an embodiment of the present disclosure.

FIG. 9 is a block diagram of an example of a computing device according to an embodiment of the present disclosure.

FIG. 10 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Unlicensed/shared spectrum

Unlicensed/shared spectrum, sidelink communication, back-to-back (B2B) transmission/multi-consecutive slot transmission, unlicensed channel access and occupancy, and mode 2 resource allocation mechanism in sidelink may be configured to implement some embodiments presented herein. The shared (also referred as unlicensed or license-exempted) radio spectrum in 2.4 GHz, 5 GHz, and 6 GHz frequency bands may be used by Wi-Fi and Bluetooth wireless technologies for short range communication (from just a few meters to few tens of meters). The popularity of using the unlicensed radio spectrum is so great that it is often claimed that more traffic is carried over the unlicensed spectrum bands than any other radio bands. The frequency spectrum is free/at no-cost to use by anyone if communication devices are compliant to certain technical regulations set out in each region. Besides Wi-Fi and Bluetooth, other radio access technologies (RATs) such as licensed-assisted access (LAA) based on fourth generation long term evolution (4G-LTE) and new radio unlicensed (NR-U) based on fifth generation new radio (5G-NR) mobile systems from 3rd generation partnership project (3GPP) also operate in the same unlicensed bands. In order for devices of different RATs (Wi-Fi, Bluetooth, LAA, NR-U, and possibly others) to operate simultaneously and coexist fairly in the same geographical area without causing severe interference and interruption to each other’s communication, a clear channel access (CCA) protocol such as listen-before-talk (LBT) adopted in LAA and NR-U and carrier sense multiple access/collision avoidance (CSMA/CA) used in Wi-Fi and Bluetooth are performed before any wireless transmission is carried out to ensure that a wireless radio does not transmit while another is already transmitting on the same channel.

For the sidelink wireless technology to operate and coexist with current RATs operating in the unlicensed frequency bands, LBT based schemes are employed to make certain there is no on-going activity on the radio channel before attempting to access the channel for transmission. For example, when a Type 1 LBT is successfully performed by a sidelink user equipment (UE), the UE has the right to access and occupy the unlicensed channel for a duration of a channel occupancy time (COT). This is called COT initiation. During an acquired COT, however, a device of another RAT could still gain access to the channel if no wireless transmission is performed by the COT initiation sidelink UE or a COT responding sidelink UE for an idle period longer than a pre-defined length (e.g., 16 or 25 µs). Hence, potentially losing the access to the channel until another successful LBT is performed. A potential solution to this issue of losing the access to the channel could be a back-to-back (B2B) transmission.

### B2B transmission/multi-consecutive slot transmission (MCSt)

The main purpose of B2B transmission (which can be also referred as “burst transmission” or “multi-consecutive slot transmission”) may be intended for a sidelink (SL) communicating UE to occupy an unlicensed channel continuously for a longer duration of time (i.e., more than one time slot) to mitigate the risk of losing access to the unlicensed channel to a wireless transmission (Tx) device of another radio access technology (RAT). This B2B transmission can be important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or with a short latency requirement (small packet delay budget (PDB)). When the unlicensed wireless channel is busy/congested (e.g., with many devices trying to access the channel simultaneously for transmission), it can be difficult and take up a long time to gain access to the channel due to the random backoff timer and priority class category in the LBT procedure. Therefore, when a UE finally has a chance/opportunity to gain access to the wireless channel for a channel occupancy time (COT) length which may last for a few milliseconds (e.g., 2, 4, 6 or 10ms), the intention is to retain the channel access for as long as possible (e.g., all or most of the COT length) to send as much data as possible by continuously transmitting in the unlicensed channel such that wireless devices of other RATs would not have a chance to access the channel.

### Unlicensed channel access and occupancy

A Type 1 LBT procedure can be perform by a UE before any SL transmission to first gain an access to an unlicensed channel and to initiate a COT. Additionally, a B2B transmission could be used to avoid large transmission gaps in order to retain the COT and the access to the channel. Beside the Type 1 LBT, a Type 2 LBT could be also used by the UE within an initiated COT or a shared COT as required by unlicensed spectrum regulation for gaps that are 25 µs or smaller. For example, in a Type 2A LBT if an unlicensed channel is sensed to be idle for 25 µs or more, the COT initiating UE is permitted to resume its transmission and/or a COT sharing UE is allowed to start its transmission within a COT. In a Type 2B LBT, the allowed transmission gap is 16 µs and Type 2C LBT (for which the UE does not need to perform channel sensing) is for gaps less than 16 µs.

In the NR-U and LAA systems, transmission gaps are unavoidable/inevitable before UE occupying the unlicensed channel due to propagation delay between gNB/gNB to the UEs in sending scheduling control information, UE switching from a receiving mode (RX) to a transmitting mode (TX), and data information encoding and modulation for an actual uplink (UL) transmission. Sometimes, these gaps could be larger than 25 µs and an extension of cyclic prefix may be first transmitted in the UL in order to avoid the unlicensed channel being taken over by other devices operating in the same spectrum band due to excessive channel idle time). The duration of the cyclic prefix extension (CPE) transmission in the UL is determined by a base station (gNB/eNB) to avoid any access blocking/denying issue among different UEs and it is indicated to each scheduled UE, and the UE simply follows the indication and performs UL transmission accordingly.

In SL communication, especially in resource allocation (RA) Mode 2, all transmission resources are to be determined and selected by the UE on its own without any base station intervention, assistance, and coordination to avoid transmission collisions. Furthermore, the SL system enables frequency domain multiplexing (FDM) of transmissions from multiple UEs in the same slot such that radio resource utilization efficiency is maximized and shortened the communication latency at the same time. But since there is no base station control and assistance to SL UEs in accessing the unlicensed channel(s), even in RA Mode 1 under a gNB scheduling, the UEs may try to access the channel at different time and using different LBT channel access procedures with different channel idle period requirements. Under this type of operating scenario, it is not possible to coordinate in advanced among the UEs transmitting in the same slot to avoid access blocking/denying to the unlicensed channel.

### Mode 2 resource allocation mechanism in sidelink

In current design of resource allocation mechanism for SL communication, a mode 2 resource selection method relies on the SL transmitting UE to perform autonomous selection of resources on its own from a pool of SL resources for transmission of data packets. In this resource allocation mode, the selection of transmission resources is not random at the start but based on a sensing and reservation strategy to avoid collision with other SL transmission UEs operating in the same resource pool. In this resource selection strategy, a transmitting UE senses the channel for a period of a sensing window (which is different from the LBT channel sensing) to decode and detect information about reservation of SL resources from other transmitting/surrounding UEs. Based on detected resource reservation information, the transmitting UE excludes resources that are already reserved from selection to avoid transmission collision and selects a number of required resources from the remaining/available (non-reserved) ones randomly for its own transmission(s). During the transmissions using the selected resources, likewise, the transmitting UE also sends out/broadcasts its own resource reservation information in the resource pool using sidelink control information (SCI) messages so that other UEs may also avoid collision by not selecting the same or an overlap resource. In the current resource indication and reservation signaling design, the time gap between two consecutive resources for reservation can be up to 31 slots apart.

Unlicensed/shared spectrum, sidelink communication, back-to-back (B2B) transmission/multi-consecutive slot transmission, unlicensed channel access and occupancy, and mode 2 resource allocation mechanism in sidelink as illustrated above may be configured to implement some embodiments presented herein. Further, some embodiments of the present disclosure provide resource selection and re-selection methods in sidelink (SL) resource allocation mode 2, the ending time of SL consecutive-slot transmission from a COT initiating UE is indicated, and the selected/reserved transmission resources are fully used by the COT initiating UE to retain the channel so that a COT sharing UE is able to determine and apply a right channel access type. In some embodiments, when a selected SL resource pool is configured with physical sidelink feedback channel (PSFCH) resources, a minimum time gap is to be ensured between any two selected sets of consecutive-slot resources to resolve the issue of potential loss of an initiated channel occupancy to another UE or device of a different RAT and at the same time to allow SL-HARQ feedback. Other benefits from using the resource selection and re-selection methods for SL communication in the unlicensed spectrum may include at least one of the followings. 1. Elimination of the requirement that SL B2B transmissions can be only used when SL-HARQ feedback is disabled or in a resource pool without PSFCH resources configured. 2. Reducing latency in delivering SL data transport blocks (TBs)/medium access control protocol data units (MAC PDUs) by minimizing the use of the minimum time gap between SL transmission. 3. Enhancing SL resource utilization and providing more candidate available resources that can be selected in a SL resource pool configured with PSFCH resources.

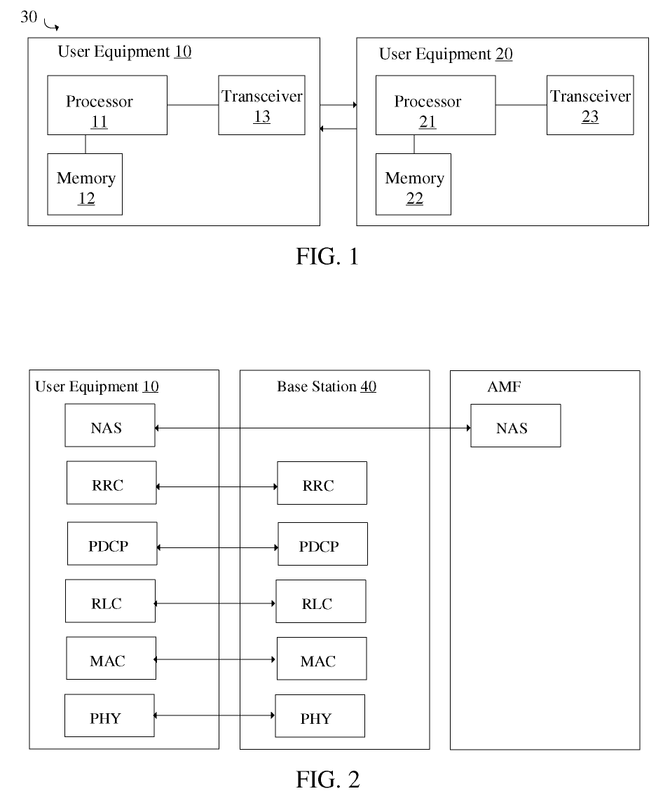

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 17 and beyond, for example providing cellular–vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 2 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to perform one or more operations to indicate to another UE, an ending time slot of a sidelink transmission and/or resources selected/reserved by the UE in a shared channel occupancy, wherein the one or more operations include a first resource re-evaluation and pre-emption checking, a second resource re-evaluation and pre-emption checking, indicating a channel occupancy time (COT) sharing starting offset and/or a COT sharing region in a sidelink control information (SCI), and/or no dropping of any sidelink (SL) transmission within a COT after a COT sharing information (COT-SI) is transmitted in the SCI from the UE. This can solve issues in the prior art and other others, improve a back-to-back (B2B) transmission, reduce transmission latency, enhance SL resource utilization, and/or improve a sidelink (SL) communication performance.

In some embodiments, the processor 11 is configured to ensure a sidelink hybrid automatic repeat request (SL-HARQ) feedback in a SL resource pool configured with physical sidelink feedback channel (PSFCH) resources to provide a minimum time gap between any two selected sets of resources of a selected sidelink grant, wherein at least one of the any two selected sets of resources is a set of consecutive-slot resources. This can solve issues in the prior art and other others, improve a back-to-back (B2B) transmission, reduce transmission latency, enhance SL resource utilization, and/or improve a sidelink (SL) communication performance.

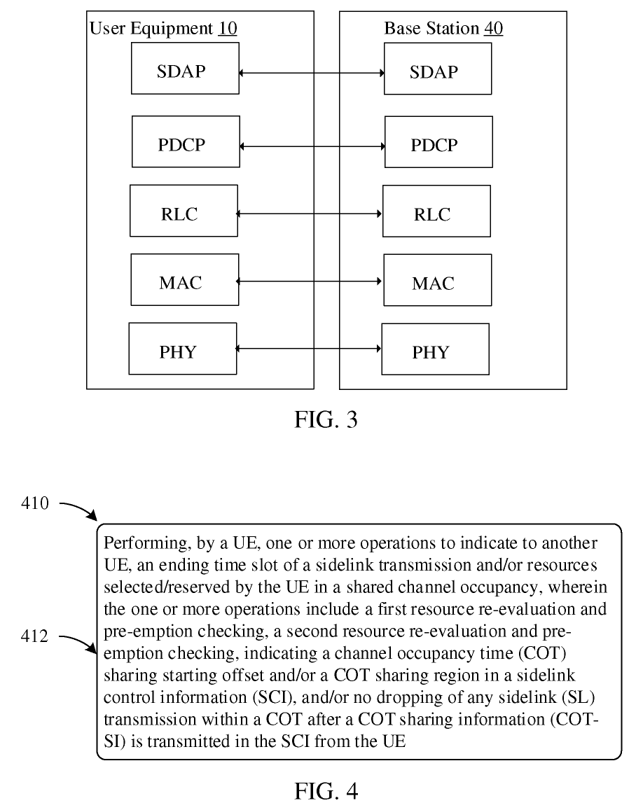

FIG. 4 illustrates a method 410 for determining a transmission gap between user equipments (UEs) in sidelink communication according to an embodiment of the present disclosure. In some embodiments, the method 410 includes: an operation 412, performing, by a UE, one or more operations to indicate to another UE, an ending time slot of a sidelink transmission and/or resources selected/reserved by the UE in a shared channel occupancy, wherein the one or more operations include a first resource re-evaluation and pre-emption checking, a second resource re-evaluation and pre-emption checking, indicating a channel occupancy time (COT) sharing starting offset and/or a COT sharing region in a sidelink control information (SCI), and/or no dropping of any sidelink (SL) transmission within a COT after a COT sharing information (COT-SI) is transmitted in the SCI from the UE. This can solve issues in the prior art and other others, improve a back-to-back (B2B) transmission, reduce transmission latency, enhance SL resource utilization, and/or improve a sidelink (SL) communication performance.

In some embodiments, the sidelink transmission spans over consecutive slots. In some embodiments, the first resource re-evaluation and pre-emption checking is performed for consecutive-slot resources at a slot before a first slot of the consecutive-slot resources in time domain or the first slot where the UE transmits the COT-SI in the SCI. In some embodiments, the first resource re-evaluation and pre-emption checking is performed for consecutive-slot resources at slot (x – T 3), where slot x is the first slot of the consecutive-slot resources or the first slot where the UE transmits the COT-SI in the SCI, and T 3 is a UE processing time subject to a sub-carrier spacing. In some embodiments, no resource re-evaluation and pre-emption checking is performed for the consecutive-slot resources within an initiated COT and/or a shared COT after the slot before the first slot in the time domain or after the slot (x – T 3).

In some embodiments, if the consecutive-slot resources or any of the consecutive-slot resources within an initiated COT an/or a shared COT is not part of a candidate resource set during the first resource re-evaluation and pre-emption checking and/or the second resource re-evaluation and pre-emption checking, the consecutive-slot resources are re-selected. In some embodiments, the second resource re-evaluation and pre-emption checking is performed for consecutive-slot resources at a slot before a slot of the consecutive-slot resources in time domain or before a slot where the UE transmits the COT-SI in the SCI. In some embodiments, the second resource re-evaluation and pre-emption checking is performed for consecutive-slot resources at slot (m-T 3), where slot m corresponds to a slot position of the consecutive-slot resources, and T 3 is a UE processing time subject to a sub-carrier spacing. In some embodiments, the slot where the second resource re-evaluation and pre-emption checking is performed or the slot ( m-T 3) does not exceed a last slot before a COT starting slot or before the slot in which the COT-SI is transmitted.

In some embodiments, the second resource re-evaluation and pre-emption checking is performed after a last slot, wherein the last slot is before a COT starting slot or before the slot in which the COT-SI is transmitted. In some embodiments, when the second resource re-evaluation and pre-emption checking is performed after the last slot and if any of the consecutive-slot resources is not part of the candidate resource set, a physical layer of the UE does not report re-evaluation and pre-emption resources to a higher layer of the UE and/or a media access control (MAC) layer does not perform re-selection for reported re-evaluation and pre-emption resources. In some embodiments, the COT sharing region is indicated in the SCI or derived by the another UE based on a COT sharing starting offset field in the SCI, a remaining COT duration field in the SCI, and/or the slot in which the SCI is received.

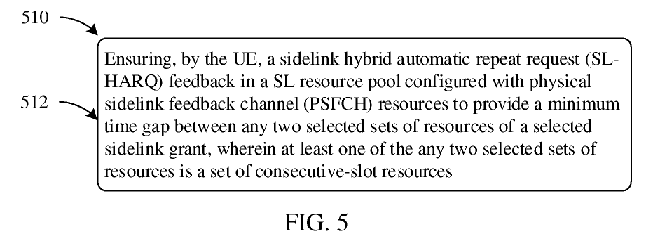

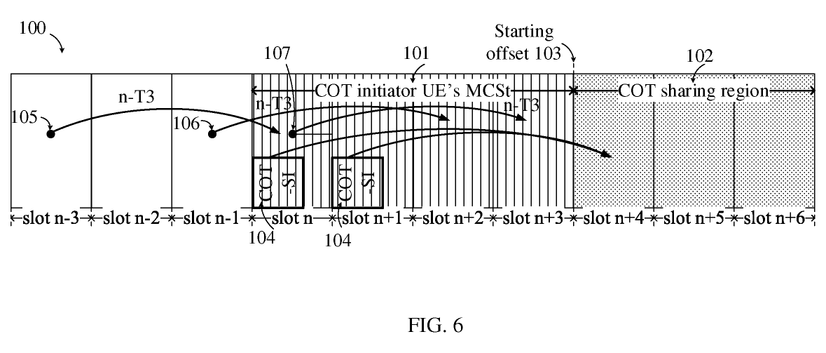

FIG. 5 illustrates a method 510 for resource allocation in sidelink communication by a user equipment (UE) according to an embodiment of the present disclosure. In some embodiments, the method 510 includes: an operation 512, ensuring, by the UE, a sidelink hybrid automatic repeat request (SL-HARQ) feedback in a SL resource pool configured with physical sidelink feedback channel (PSFCH) resources to provide a minimum time gap between any two selected sets of resources of a selected sidelink grant, wherein at least one of the any two selected sets of resources is a set of consecutive-slot resources. This can solve issues in the prior art and other others, improve a back-to-back (B2B) transmission, reduce transmission latency, enhance SL resource utilization, and/or improve a sidelink (SL) communication performance.

In some embodiments, the minimum time gap includes a time gap between an end or a last symbol of a consecutive-slot transmission for physical sidelink shared channel (PSSCH) and a beginning of a corresponding PSFCH reception, a time required for processing a received PSFCH, and a time required to prepare sidelink retransmission of a transport block (TB) or a medium access control (MAC) packet data unit (PDU) for the selected sidelink grant. In some embodiments, when the UE performs multiple transmissions of the same TB or MAC PDU in consecutive slots and a higher layer of the UE indicates a value of a HARQ feedback indicator field is 1 or enabled, a physical layer of the UE sets the value of the HARQ feedback indicator field 1 or enabled in a last slot of the consecutive-slot transmission.

In some embodiments, the value of the HARQ feedback indicator field is set to 0 or disabled in all other slots of the consecutive-slot transmission, except in the last slot. In some embodiments, the UE is configured to determine a hybrid automatic repeat request acknowledgement (HARQ-ACK) information in response to a PSSCH reception in a last slot of a consecutive-slot transmission and/or determine a corresponding PSFCH resource to transmit the HARQ-ACK information when a HARQ feedback indicator value is set to 1 or enabled in a sidelink control information (SCI). In some embodiments, when the UE performs multiple transmissions of the same TB or MAC PDU in consecutive slots, a higher layer of the UE indicates a value of a HARQ feedback indicator field in a SCI.

In some embodiments, when the UE detects a consecutive-slot transmission is intended for the same TB or MAC PDU based on a SCI, the UE determines a HARQ-ACK information in response to a PSSCH reception in a last slot of the consecutive-slot transmission and/or determines a corresponding PSFCH resource to transmit the HARQ-ACK information when a HARQ feedback indicator value is set to 1 or enabled in the SCI. In some embodiments, the SCI includes a time resource assignment, a HARQ process number, a source identifier (ID), a destination ID, a redundancy version, and/or a HARQ feedback indicator.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### Examples:

A sidelink (SL) user equipment (UE) operating in resource allocation Mode 2 selects and reserves resources for transmitting control and data channels autonomously on its own based on a sensing and reservation strategy. However, the occurrence of overlapping resource selection/reservation is possible between two transmitting UEs in some scenarios when one UE failed to detect another UE’s reservation signal (e.g., due to a half-duplex issue, lacking receiver chains, etc.), or a resource is selected firstly by one UE but later reserved by another UE. To mitigate the effect of overlapping resources, a resource re-evaluation and pre-emption checking mechanism was introduced for a transmitting UE may “double check” the availability of its selected/reserved resource just before its transmission using the resource. If an overlapping reservation is detected and certain other criteria are fulfilled, the transmitting UE re-selects of the resource to avoid collision. This mechanism works well for new radio (NR) vehicle-to-everything (V2X) communication in a dedicated spectrum for intelligent transportation system (ITS). However, this may create an issue in a shared channel occupancy where operating devices are always contending for their access to the unlicensed channel.

For SL communication in the unlicensed spectrum, in the case when a channel occupancy time (COT) initiating UE intends to share its initiated COT to one or more other UEs by transmitting a COT sharing information (COT-SI) in sidelink control information (SCI), a UE who intends to shred the COT from the initiator UE needs to determine and perform an appropriate Type 2 listen-before-talk (LBT) mechanism (2A or 2B) based on the transmission gap in order to access the channel. If the gap between the end of initiator UE’s and the beginning of COT sharing UE’s transmissions is equal to or larger than 25 µs, then Type 2A LBT is performed by the COT sharing UE; otherwise, if the gap is 16 µs, then Type 2B is performed. As such, if the initiator UE drops its SL transmission (e.g., due to prioritization) or re-selects a resource to a different slot (e.g., due to re-evaluation and pre-emption checking), an additional transmission gap of one slot is created, and in this case the COT sharing UE needs to perform Type 2A LBT to access the channel. When there is no slot gap, the COT sharing UE would only need to perform Type 2B LBT in conjunction with cyclic prefix extension (CPE) transmission to fill-in the gap symbol at the end of a SL slot. Therefore, it is crucial for the COT sharing UE to know or be able to determine the exact timing by which the COT initiator UE stops SL transmission. But there is a possibility that the COT initiator may drop a SL transmission or re-selects an already reserved resource within a COT and create an uncertainty in the Type of LBT that the COT sharing UE should perform to access the channel in order to be compliant to local regulations.

In order to resolve the issue of uncertainty in the transmission gap between two SL transmitting UEs within a shared channel occupancy, in one embodiment of the present disclosure of methods for resource selection and re-selection in SL communication, it is proposed to ensure the ending time of SL transmission(s) from a first UE (e.g., the COT initiating UE) is informed and maintained by adopting one or more of the following method options.

### Option 1: First resource re-evaluation and pre-emption checking

In some examples, the first resource re-evaluation and pre-emption checking may be a group-based resource re-evaluation and pre-emption checking.

In one example, the resource re-evaluation and pre-emption checking procedure in SL resource allocation Mode 2 is performed for the consecutive-slot resources by the first UE only at slot (x – T 3), where slot x is the first slot of the consecutive-slot resources or the first slot where the first UE transmits COT-SI in SCI. If the consecutive-slot resources (e.g., a MCSt resource) or any of the consecutive-slot resources within the initiated or shared COT is not part of a candidate resource set (S A), the set of consecutive-slot resources are re-selected.

That is, no more resource re-evaluation and pre-emption checking is performed for the consecutive-slot resources within the initiated or shared COT after slot (x – T 3) to avoid a potential re-selection of resources that are committed by the first UE for transmission until the COT is shared utilized by another UE.

FIG. 6 illustrates an exemplary illustration of a proposed SL resource selection and re-selection mechanism for a SL transmission spans over consecutive slots in a shared channel occupancy. As exemplary illustrated in diagram 100 of FIG. 6, assuming a first SL UE intends to initiate a COT for a consecutive-slot transmission 101 (e.g., a MCSt) using a set of selected or reserved resources in slot n to slot n+3, and the first UE also intends to share the initiated COT with other UE(s) by transmitting COT-SI 104 in slot n and slot n+1 indicating at least a COT sharing starting offset 103 and possibly a COT sharing region 102. When a target COT sharing UE (e.g., a second UE) receives the COT-SI in either or both slot n and n+1, it is understood that the first UE intends to occupy the radio channel until slot n+3 and that the first available slot for it to utilize the shared COT starts from slot n+4 (i.e., only within the COT sharing region 102).

According to the proposed Option 1 for a resource group-based re-evaluation and pre-emption checking, the re-evaluation and pre-emption checking for the group of consecutive slots/resources is performed only in slot (x – T 3). When slot x is the first slot of the consecutive-slot resources (slot n) and the length of T 3 is 3 slots (e.g., when the sub-carrier spacing is 15kHz for the SL carrier or SL BWP), the re-evaluation and pre-emption checking should only be performed in slot n-3 (105).

### Option 2: Second resource re-evaluation and pre-emption checking

The second resource re-evaluation and pre-emption checking may be a resource-based resource re-evaluation and pre-emption checking.

In another example, the resource re-evaluation and pre-emption checking procedure in SL resource allocation Mode 2 is performed by the first UE at slot (m-T 3), where slot m corresponds to the slot positions of the consecutive-slot resources. However, slot (m-T 3) should not exceed the last slot immediately before the COT starting slot or before the slot in which the COT-SI is transmitted. That is, this slot is the last opportunity to perform re-evaluation and pre-emption checking for the consecutive-slot resources, and that the first UE should perform re-evaluation and pre-emption checking only until (up to) this last opportunity. During the re-evaluation and pre-emption checking, if any of the selected or reserved consecutive-slot resources is not part of a candidate resource set (S A), the set of consecutive-slot resources within the initiated/shared COT are re-selected. Hence, no more re-evaluation and per-emption checking should be performed by the first UE after the last opportunity for resources within the COT. Once the COT-SI is transmitted, the COT initiating UE is committed to transmit using all the resource slots until the beginning of the COT sharing region.

Alternatively, the re-evaluation and pre-emption checking can still be performed after the last opportunity slot/timing by the first UE. In this case, when any of the consecutive-slot resources is not part of a candidate resource set (S A), either the PHY layer does not report re-evaluation and pre-emption resources to the higher layer, or the MAC layer does not perform resource re-selection for the reported re-evaluation and pre-emption resources.

Continuing from the exemplary illustration in diagram 100 of FIG. 6, in the proposed Option 2 of the new resource selection procedure for SL transmission in an unlicensed spectrum, the re-evaluation and pre-emption checking for the set of resources within a consecutive-slot transmission 101, if a first UE who initiates a COT and intends to share a part of its COT 102 by transmitting COT-SI in SCI 104, the last opportunity to perform re-evaluation and pre-emption checking is in slot n-1106, which is the last slot immediately before the COT starting slot n. In this case, it is also the last slot immediately before the slot in which the COT-SI is transmitted 104.

Alternatively, if the re-evaluation and pre-emption checking is still performed after the last opportunity slot/timing by the first UE (that is the re-evaluation and pre-emption checking is triggered in slot n 107 for the selected/reserved resource in slot n+3), and if the resource found to be not within the set of candidate resources (S A), the PHY layer of the UE does not report re-evaluation or pre-emption for the resource to the higher layer or the MAC layer does not perform resource re-selection for the reported resource in slot n+3.

Option 3: Continuing from the exemplary illustration in diagram 100 of FIG. 6, in one example, a COT sharing starting offset (103) and/or a COT sharing region (102) is indicated in the SCI from the COT initiating UE. The COT sharing region may be indicated/derived based on the COT sharing starting offset field in SCI, a remaining COT duration field in SCI and/or the slot in which the SCI is received. By indicating this information in SCI, a target receiver UE who can utilize the shared COT can precisely determine the slot timing in which it can start the utilization and the appropriate LBT type to access the channel for its transmission. For example, although the target receiver UE can utilize the shared channel occupancy from the first UE in the COT sharing region 102, it may only have selected or reserved a resource for transmission in slot n+5. In this case, since slot n+4 is not utilized creating a transmission gap larger than 25 µs between the last transmission from the COT initiator UE and the start of the target receiver UE’s intended transmission, the target receiver UE applies LBT Type 2A just prior to the intended transmission in slot n+5. In another case, if the target receiver UE wants to transmit immediately in slot n+4 after initiator UE’s last transmission in slot n+3, then the target receiver UE has a choice of performing LBT Type 2A or 2B depending on the selected CPE length at the end of the slot n+3. Hence, this demonstrates the importance of knowing precisely the timing in which the COT initiator UE may stop SL transmission so that a COT sharing UE can determine a right LBT type to access the channel.

Option 4: In another example, no dropping of a SL transmission should be ensured within a COT after the COT initiating UE has transmitted COT-SI in SCI, (104) in diagram 100 in FIG. 6. When no SL transmission is dropped (e.g., due to prioritization) within a shared channel occupancy, no additional transmission gap can be created in the COT. The COT sharing UE would then be certain that the ending time of SL transmission from the first UE is maintained, and subsequently determine the appropriate LBT type to access the channel and comply with regional regulation. Hence, dropping of a SL transmission within a shared channel occupancy is not allowed/is avoided once the COT-SI is sent.

Further, according to the legacy/existing resource selection mechanism for transmitting a transport block (TB) or medium access control protocol data unit (MAC PDU) in a sidelink resource pool configured with physical sidelink feedback channel (PSFCH) resources, a minimum time gap of Z slots is to be ensured during the resource selection procedure between any two consecutive transmissions (i.e., with at least one PSFCH feedback opportunity occasion) in order to obtain SL-HARQ feedback from a receiver UE and perform PSSCH encoding for the subsequent retransmission when a “negative acknowledgement” (NACK) is reported. However, in the case of resource selection for continuous transmission of the same TB in order to retain access to an unlicensed channel, there should be no gap in the transmission. If a TX gap exists in the transmission, it is considered the COT is lost according to the current regulation for the unlicensed channel access or the UE runs a risk of losing the channel to another UE or device of another RAT.

In order to resolve the issue of potential loss of a COT to another UE or device of a different RAT and at the same time to allow SL-HARQ feedback in a resource pool configured with PSFCH resources, in another embodiment of the present disclosure of methods for resource selection and re-selection in SL communication, it is proposed a minimum time gap is only to be ensured between any two selected sets of consecutive-slot resources of the selected sidelink grant to retain an initiated COT, when the selected SL resource pool is configured with PSFCH resources. The minimum time gap includes a time gap between the end/the last symbol of a consecutive-slot transmission for PSSCH and the beginning of the corresponding PSFCH reception, a time required for processing a received PSFCH, and a time required to prepare sidelink retransmission of a TB or MAC PDU for the selected sidelink grant.

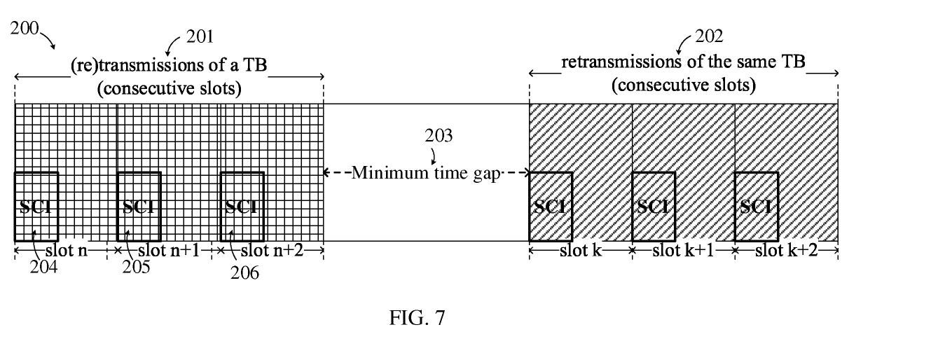

FIG. 7 illustrates an exemplary illustration of a proposed resource (re)selection method of ensuring a minimum time gap placed between two sets of consecutive-slot transmissions of the same TB. As exemplary illustrated in diagram 200 of FIG. 7, when a first UE selects a set of resources for multiple transmissions (including retransmissions of a TB or MAC PDU) in consecutive-slot 201 and another set of consecutive-slot resources for retransmissions of the same TB 202, a sufficient minimum time gap 203 is placed/ensured during the resource selection and re-selection procedure to allow an opportunity of SL-HARQ feedback in PSFCH.

Furthermore, the proposed minimum time gap solution can be further combined with one of the following options for handling SL-HARQ feedback in PSFCH.

### Option A:

When a SL UE performs multiple transmissions of the same TB or MAC PDU in consecutive slots and the higher layer indicates the value of the ‘HARQ feedback indicator’ field is set to 1 (i.e., enabled), the PHY layer is set the value of the ‘HARQ feedback indicator’ field to 1 only in the last slot of the consecutive-slot transmission 206. That is, the value of the ‘HARQ feedback indicator’ field is set to 0 (i.e., disabled) in all other slots 204 and 205 (except for the last slot) of the consecutive-slot transmission.

Subsequently, a receiver UE determines HARQ-ACK information in response only to a PSSCH reception in the last slot of the consecutive-slot transmission and determines a corresponding PSFCH resource to transmit the HARQ-ACK information when the ‘HARQ feedback indicator’ value is set to 1 (enabled) in the received/associated SCI 206.

### Option B:

A SL UE performs multiple (re)transmissions of the same TB or MAC PDU in consecutive slots, the value of the ‘HARQ feedback indicator’ field in SCI is set as indicated by higher layers. In reference to the exemplary illustration in diagram 200 of FIG. 7, this refers to all SCIs (204, 205, 206) transmitted in slot n, n+1 and n+2. When a receiver UE detects a consecutive-slot transmission is intended for the same TB or MAC PDU based on one or more of the following information in SCI, the receiver UE determines HARQ-ACK information in response only to a PSSCH reception in the last slot of the consecutive-slot transmission (slot n+2 in Diagram 200) and determines a corresponding PSFCH resource to transmit the HARQ-ACK information when the ‘HARQ feedback indicator’ value is set to 1 (enabled) in the received/associated SCI 206. The SCI includes a time resource assignment, a HARQ process number, a source identifier (ID), a destination ID, a redundancy version, and/or a HARQ feedback indicator.

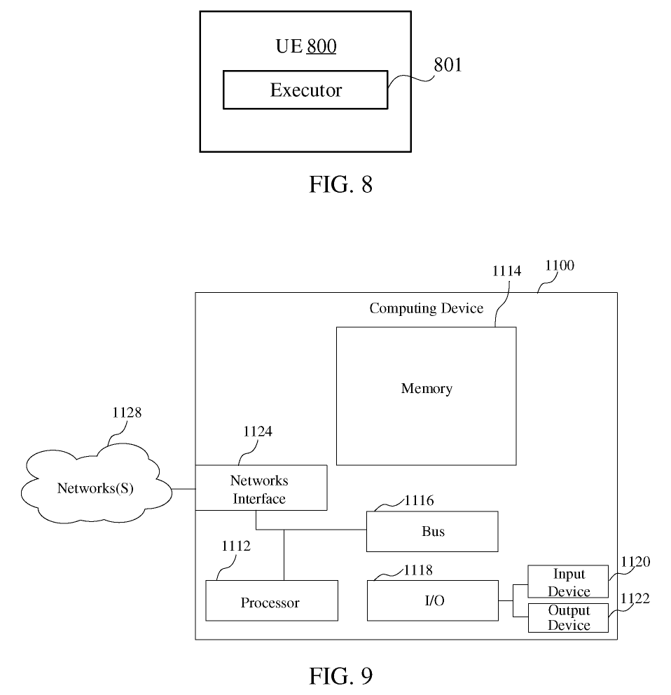

FIG. 8 illustrates a UE 800 for wireless communication according to an embodiment of the present disclosure. The UE 800 includes an executor 801 configured to perform one or more operations to indicate to another UE, an ending time slot of a sidelink transmission and/or resources selected/reserved by the UE in a shared channel occupancy; wherein the one or more operations include a first resource re-evaluation and pre-emption checking, a second resource re-evaluation and pre-emption checking, indicating a channel occupancy time (COT) sharing starting offset and/or a COT sharing region in a sidelink control information (SCI), and/or no dropping of any sidelink (SL) transmission within a COT after a COT sharing information (COT-SI) is transmitted in the SCI from the UE. This can solve issues in the prior art and other others, improve a back-to-back (B2B) transmission, reduce transmission latency, enhance SL resource utilization, and/or improve a sidelink (SL) communication performance.

In some embodiments, the sidelink transmission spans over consecutive slots. In some embodiments, the first resource re-evaluation and pre-emption checking is performed for consecutive-slot resources at a slot before a first slot of the consecutive-slot resources in time domain or the first slot where the UE transmits the COT-SI in the SCI. In some embodiments, the first resource re-evaluation and pre-emption checking is performed for consecutive-slot resources at slot (x – T 3), where slot x is the first slot of the consecutive-slot resources or the first slot where the UE transmits the COT-SI in the SCI, and T 3 is a UE processing time subject to a sub-carrier spacing. In some embodiments, no resource re-evaluation and pre-emption checking is performed for the consecutive-slot resources within an initiated COT and/or a shared COT after the slot before the first slot in the time domain or after the slot (x – T 3).

In some embodiments, if the consecutive-slot resources or any of the consecutive-slot resources within an initiated COT an/or a shared COT is not part of a candidate resource set during the first resource re-evaluation and pre-emption checking and/or the second resource re-evaluation and pre-emption checking, the consecutive-slot resources are re-selected. In some embodiments, the second resource re-evaluation and pre-emption checking is performed for consecutive-slot resources at a slot before a slot of the consecutive-slot resources in time domain or before a slot where the UE transmits the COT-SI in the SCI. In some embodiments, the second resource re-evaluation and pre-emption checking is performed for consecutive-slot resources at slot (m-T 3), where slot m corresponds to a slot position of the consecutive-slot resources, and T 3 is a UE processing time subject to a sub-carrier spacing. In some embodiments, the slot where the second resource re-evaluation and pre-emption checking is performed or the slot (m-T 3) does not exceed a last slot before a COT starting slot or before the slot in which the COT-SI is transmitted.

In some embodiments, the second resource re-evaluation and pre-emption checking is performed after a last slot, wherein the last slot is before a COT starting slot or before the slot in which the COT-SI is transmitted. In some embodiments, when the second resource re-evaluation and pre-emption checking is performed after the last slot and if any of the consecutive-slot resources is not part of the candidate resource set, a physical layer of the UE does not report re-evaluation and pre-emption resources to a higher layer of the UE and/or a media access control (MAC) layer does not perform re-selection for reported re-evaluation and pre-emption resources. In some embodiments, the COT sharing region is indicated in the SCI or derived by the another UE based on a COT sharing starting offset field in the SCI, a remaining COT duration field in the SCI, and/or the slot in which the SCI is received.

In some embodiments, the UE 800 includes an executor 801 configured to ensure a sidelink hybrid automatic repeat request (SL-HARQ) feedback in a SL resource pool configured with physical sidelink feedback channel (PSFCH) resources to provide a minimum time gap between any two selected sets of resources of a selected sidelink grant, wherein at least one of the any two selected sets of resources is a set of consecutive-slot resources. This can solve issues in the prior art and other others, improve a back-to-back (B2B) transmission, reduce transmission latency, enhance SL resource utilization, and/or improve a sidelink (SL) communication performance.

In some embodiments, the minimum time gap includes a time gap between an end or a last symbol of a consecutive-slot transmission for physical sidelink shared channel (PSSCH) and a beginning of a corresponding PSFCH reception, a time required for processing a received PSFCH, and a time required to prepare sidelink retransmission of a transport block (TB) or a medium access control (MAC) packet data unit (PDU) for the selected sidelink grant. In some embodiments, when the UE performs multiple transmissions of the same TB or MAC PDU in consecutive slots and a higher layer of the UE indicates a value of a HARQ feedback indicator field is 1 or enabled, a physical layer of the UE sets the value of the HARQ feedback indicator field 1 or enabled in a last slot of the consecutive-slot transmission.

In some embodiments, the value of the HARQ feedback indicator field is set to 0 or disabled in all other slots of the consecutive-slot transmission, except in the last slot. In some embodiments, the UE is configured to determine a hybrid automatic repeat request acknowledgement (HARQ-ACK) information in response to a PSSCH reception in a last slot of a consecutive-slot transmission and/or determine a corresponding PSFCH resource to transmit the HARQ-ACK information when a HARQ feedback indicator value is set to 1 or enabled in a sidelink control information (SCI). In some embodiments, when the UE performs multiple transmissions of the same TB or MAC PDU in consecutive slots, a higher layer of the UE indicates a value of a HARQ feedback indicator field in a SCI.

In some embodiments, when the UE detects a consecutive-slot transmission is intended for the same TB or MAC PDU based on a SCI, the UE determines a HARQ-ACK information in response to a PSSCH reception in a last slot of the consecutive-slot transmission and/or determines a corresponding PSFCH resource to transmit the HARQ-ACK information when a HARQ feedback indicator value is set to 1 or enabled in the SCI. In some embodiments, the SCI includes a time resource assignment, a HARQ process number, a source identifier (ID), a destination ID, a redundancy version, and/or a HARQ feedback indicator.

Commercial interests for some embodiments are as follows. 1. Solving issues in the prior art and other issues. 2. Improving a back-to-back (B2B) transmission. 3. Reducing transmission latency. 4. Enhancing SL resource utilization. 5. Improving a sidelink (SL) communication performance. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed application and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

FIG. 9 is a block diagram of an example of a computing device according to an embodiment of the present disclosure. Any suitable computing device can be used for performing the operations described herein. For example, FIG. 9 illustrates an example of the computing device 1100 that can implement some embodiments in FIG. 1 to FIG. 8, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 8. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

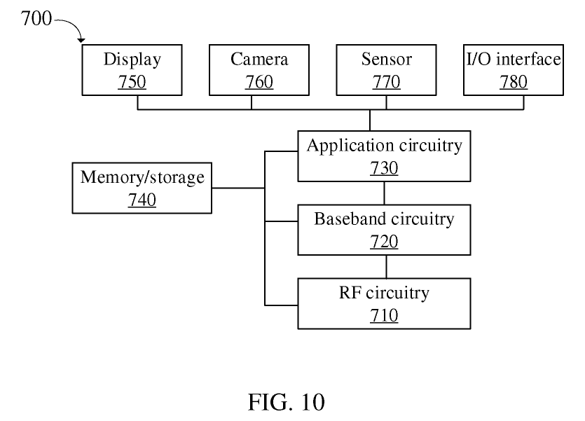

FIG. 10 is a block diagram of an example system 700 for wireless communication according to an embodiment of the present disclosure. Embodiments described herein may be implemented into the system using any suitably configured hardware and/or software. FIG. 10 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method for determining a transmission gap between user equipments (UEs) in sidelink communication, comprising:
performing, by a UE, one or more operations to indicate to another UE, an ending time slot of a sidelink transmission and/or resources selected/reserved by the UE in a shared channel occupancy;
wherein the one or more operations comprise:
a first resource re-evaluation and pre-emption checking;
a second resource re-evaluation and pre-emption checking;
indicating a channel occupancy time (COT) sharing starting offset and/or a COT sharing region in a sidelink control information (SCI); and/or
no dropping of any sidelink (SL) transmission within a COT after a COT sharing information (COT-SI) is transmitted in the SCI from the UE.

2. The method of claim 1, wherein the sidelink transmission spans over consecutive slots.

3. The method of claim 1, wherein the first resource re-evaluation and pre-emption checking is performed for consecutive-slot resources at a slot before a first slot of the consecutive-slot resources in time domain or the first slot where the UE transmits the COT-SI in the SCI.

4. The method of claim 1, wherein the first resource re-evaluation and pre-emption checking is performed for consecutive-slot resources at slot (x – T3), where slot x is the first slot of the consecutive-slot resources or the first slot where the UE transmits the COT-SI in the SCI, and T3 is a UE processing time subject to a sub-carrier spacing.

5. The method claim 4, wherein no resource re-evaluation and pre-emption checking is performed for the consecutive-slot resources within an initiated COT and/or a shared COT after the slot before the first slot in the time domain or after the slot (x – T3).

6. The method of claim 1, wherein if the consecutive-slot resources or any of the consecutive-slot resources within an initiated COT an/or a shared COT is not part of a candidate resource set during the first resource re-evaluation and pre-emption checking and/or the second resource re-evaluation and pre-emption checking, the consecutive-slot resources are re-selected.

7. The method of claim 1, wherein the second resource re-evaluation and pre-emption checking is performed for consecutive-slot resources at a slot before a slot of the consecutive-slot resources in time domain or before a slot where the UE transmits the COT-SI in the SCI.

8. The method of claim 1, wherein the second resource re-evaluation and pre-emption checking is performed for consecutive-slot resources at slot (m-T3), where slot m corresponds to a slot position of the consecutive-slot resources, and T3 is a UE processing time subject to a sub-carrier spacing.

9. The method of claim 8, wherein the slot where the second resource re-evaluation and pre-emption checking is performed or the slot (m-T3) does not exceed a last slot before a COT starting slot or before the slot in which the COT-SI is transmitted.

10. The method of claim 1, wherein the second resource re-evaluation and pre-emption checking is performed after a last slot, wherein the last slot is before a COT starting slot or before the slot in which the COT-SI is transmitted.

11. The method of claim 10, wherein when the second resource re-evaluation and pre-emption checking is performed after the last slot and if any of the consecutive-slot resources is not part of the candidate resource set, a physical layer of the UE does not report re-evaluation and pre-emption resources to a higher layer of the UE and/or a media access control (MAC) layer does not perform re-selection for reported re-evaluation and pre-emption resources.

12. The method of claim 1, wherein the COT sharing region is indicated in the SCI or derived by the another UE based on a COT sharing starting offset field in the SCI, a remaining COT duration field in the SCI, and/or the slot in which the SCI is received.

13. A method for resource allocation in sidelink communication by a user equipment (UE), comprising:
ensuring, by the UE, a sidelink hybrid automatic repeat request (SL-HARQ) feedback in a SL resource pool configured with physical sidelink feedback channel (PSFCH) resources to provide a minimum time gap between any two selected sets of resources of a selected sidelink grant, wherein at least one of the any two selected sets of resources is a set of consecutive-slot resources.

14. The method of claim 13, wherein the minimum time gap comprises a time gap between an end or a last symbol of a consecutive-slot transmission for physical sidelink shared channel (PSSCH) and a beginning of a corresponding PSFCH reception, a time required for processing a received PSFCH, and a time required to prepare sidelink retransmission of a transport block (TB) or a medium access control (MAC) packet data unit (PDU) for the selected sidelink grant.

15. The method of claim 13, wherein when the UE performs multiple transmissions of the same TB or MAC PDU in consecutive slots and a higher layer of the UE indicates a value of a HARQ feedback indicator field is 1 or enabled, a physical layer of the UE sets the value of the HARQ feedback indicator field 1 or enabled in a last slot of the consecutive-slot transmission.

16. The method of claim 15, wherein the value of the HARQ feedback indicator field is set to 0 or disabled in all other slots of the consecutive-slot transmission, except in the last slot.

17. The method of claim 13, wherein the UE is configured to determine a hybrid automatic repeat request acknowledgement (HARQ-ACK) information in response to a PSSCH reception in a last slot of a consecutive-slot transmission and/or determine a corresponding PSFCH resource to transmit the HARQ-ACK information when a HARQ feedback indicator value is set to 1 or enabled in a sidelink control information (SCI).

18. The method of claim 13, wherein when the UE performs multiple transmissions of the same TB or MAC PDU in consecutive slots, a higher layer of the UE indicates a value of a HARQ feedback indicator field in a SCI.

19. The method of claim 13, wherein when the UE detects a consecutive-slot transmission is intended for the same TB or MAC PDU based on a SCI, the UE determines a HARQ-ACK information in response to a PSSCH reception in a last slot of the consecutive-slot transmission and/or determines a corresponding PSFCH resource to transmit the HARQ-ACK information when a HARQ feedback indicator value is set to 1 or enabled in the SCI.

20. The method of claim 18, wherein the SCI comprises a time resource assignment, a HARQ process number, a source identifier (ID), a destination ID, a redundancy version, and/or a HARQ feedback indicator.
